(19) United States
(12) Patent Application Publication
(10) Pub. No.: US 2011/0014464 A1
(43) Pub. Date: Jan. 20, 2011

(54) TWIN ADHESIVE TAPE

(76) Inventor: Jianbing Tu, Ninghai (CN)

Correspondence Address: Wilson Wu, 19 Clipper Road, North York, Toronto, ON, M2J4C8, CA

(21) Appl. No.: 12/890,605

(22) Filed: Sep. 25, 2010

Related U.S. Application Data
(63) Continuation-in-part of application No. 12/385,873, filed on Apr. 22, 2009.

(30) Foreign Application Priority Data
Jul. 22, 2008 (CN) 200810040875.9

(51) Int. Cl. B32B 7/06

(52) U.S. Cl. 428/352

(57) ABSTRACT

A twin adhesive tape has a release substrate, an adhesive layer adhesively and detachably attached to the release substrate. The adhesive layer has a lower adhesive layer, a printing substrate securely attached to the lower adhesive layer, a layer of plastic printing ink printed on the printing substrate, and an upper adhesive layer securely attached to the layer of plastic printing ink. The twin adhesive tape having an informative figure is thin, and able to use with a hand-held tape box.

### CROSS-REFERENCE TO RELATED APPLICATIONS

This is a Continuation-In-Part application of a U.S. utility patent application 12/385,873.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a twin adhesive tape, and more particularly, to a thin twin adhesive tape having a figure printed on a printing substrate under an upper adhesive layer.

2. Description of Related Art

U.S. patent Pub. No. 2006/0121229 A1 by Nagae et al. discloses a twin adhesive tape (24a) ([0060-0061] with reference to FIG. 6) including a transparent adhesive layer (71), a polyester film (73), a temperature-indicating material (80a), a printing layer (75), a adhesive layer (77) and a double-sided release paper (79). The temperature-indicating material (80a) is able to change color according to temperature ([0065]).

This twin adhesive has two main drawbacks. First, since the technical prejudice that a printed material (80a) cannot directly contact an adhesive layer and must be covered by a “protection” layer, a polyester film (73) is provided. There might be other objects for the layer of polyester film (73) such as strengthening the twin adhesive tape (24a). After numerous experiments, it is proved that in terms of printing material protection, the covering layer is unnecessary. And for normal use, a double sided adhesive tape does not need a large strength. However, the existence of such a layer as the polyester film (73) notably increases a thickness of such twin adhesive tape. For a same length of useful tape, a packaged volume and weight become large. And when attaches a pile of such as papers, a portion which the tapes sandwiched between papers looks much thicker than other part. It negatively affects appearance of the pile.

Second, the disclosed printing material is only able to give Out information by changing colors. In overcoming another technical prejudice that twin adhesive tape is not a suitable place to express more information, it is thought that a new twin adhesive tape bearing richer information such as advertising words, drawings, and logos is desirable.

### BRIEF SUMMARY OF THE INVENTION

The main object of the invention is to provide a twin adhesive tape with a layer of printing material which is thin.

Another object of the invention is to provide a thin twin adhesive tape bearing a printed figure which is able to express more information.

In order to accomplish the above objects, the present invention provides a twin adhesive tape having a release substrate and an adhesive layer adhesively and detachably attached to the release substrate. The adhesive layer has a lower adhesive layer, a printing substrate securely attached to the lower adhesive layer, a figure formed by a layer of plastic printing ink printed on the printing substrate, and an upper adhesive layer securely attached to the layer of plastic printing ink.

These and other objectives, features, and advantages of the present invention will become apparent from the following, detailed description, the accompanying drawings, and the appended claims.

### BRIEF DESCRIPTION OF THE SEVERAL VIEWS OF THE DRAWINGS

FIG. 1 is a cross-sectional view of the preferred embodiment of the twin adhesive tape of the invention with an upper substrate is removed.

FIG. 2 is a partial and cross-sectional view of the preferred embodiment shown in FIG. 1.

FIG. 3 is a cross-sectional view of another embodiment of the twin adhesive tape of the invention.

FIG. 4 is a schematic perspective view showing when the twin adhesive tape of the invention is used with a hand-held tape box.

FIG. 5 is a flat exploded view showing the twin adhesive tape and the hand-held tape box used therewith as shown in FIG. 4. And,

FIG. 6 is a cross-sectional view of the twin adhesive tape shown in FIGS. 4 and 5.

### DETAILED DESCRIPTION OF THE INVENTION

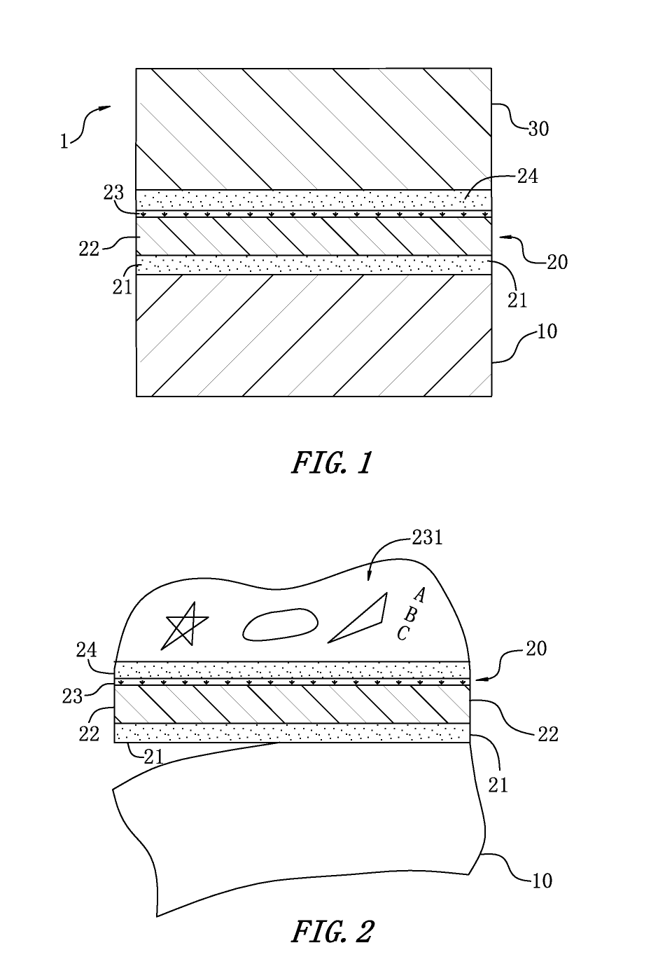

With reference to FIGS. 1 and 2, the preferred embodiment of a twin adhesive tape 1 of the invention is shown. The twin adhesive tape 1 has a release substrate 10 which is made of paper or plastic film, and an adhesive layer 20 adhesively and detachably attached thereto. The adhesive layer 20 has a lower adhesive layer 21, a printing substrate 22 securely attached to the lower adhesive layer 21, a layer of plastic printing ink 23 printed on the printing substrate 22, and an upper adhesive layer 24 securely attached to the layer of plastic printing ink 23. In this preferred embodiment, the adhesive layer 20 attaches to the release substrate 10 with the lower adhesive layer 21 thereof. A release cover 30, which is made of paper or plastic film, is attached to the upper adhesive layer 24 of the adhesive layer 20.

As particularly shown in FIG. 2, when the release cover 30 is removed from the adhesive layer 20, a user will be able to see a FIG. 231 printed on the printing substrate 22. The FIG. 231 can be for decoration or advertisement. A thickness of the printing substrate 22 may be between 0.005 and 0.02 millimeter. The printing substrate 22 is able to be made of such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion). It is noted that in a normal use of a twin adhesive tape, the adhesive layer 20 itself does not need a great strength. Before applied to an object surface, it is protected by release substrates from torn apart. The adhesive layer 20 is only needed to as strong as not easily deformable in applying, which the printing substrate 22, without aid from a protecting cover layer, will satisfy.

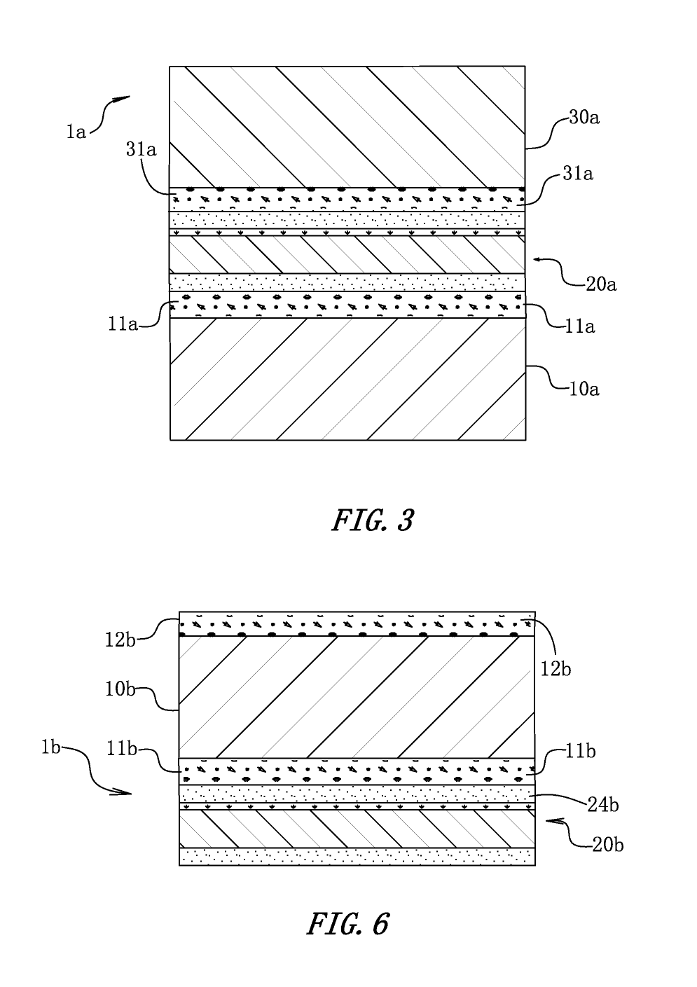

With reference to FIG. 3, a cross-sectional view of another embodiment of the twin adhesive tape 1a of the invention is shown. In this embodiment, an anti-adhesion coating layer 11a is provided on a surface of the release substrate 10a attaching the adhesive layer 20a. And a cover anti-adhesion coating layer 31a is provided on a surface of the release cover 30a attaching the adhesive layer 20a. The anti-adhesion coating layers 11a and 31a are able to be made of silicon oil diluted with number 120 gasoline.

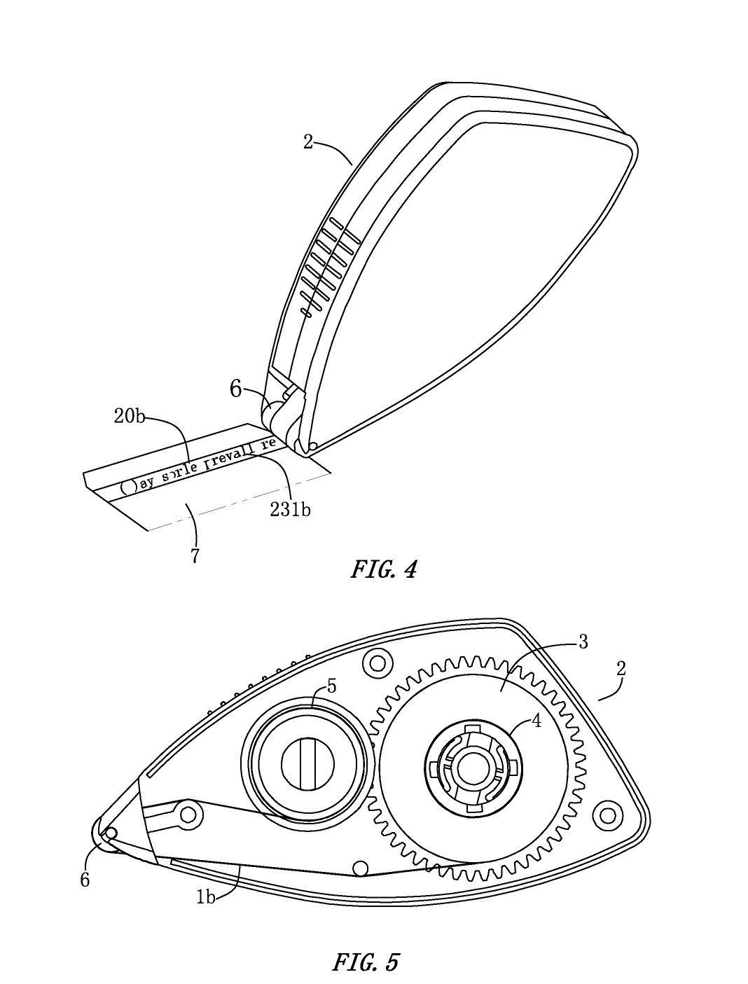

With reference to FIGS. 4, 5 and 6, another embodiment of the twin adhesive tape lb of the invention is shown. An adhesive layer 20b attaches to the release substrate 10b with an upper adhesive layer 24b thereof and an anti-adhesion coating layer 11b, 12b is provided on each surface of the release substrate 10b. The twin adhesive tape lb is a narrow and long tape, wound into a coil 3, and used with a hand-held tape box 2. The coil 3 is able to be installed on a loading spool 4. A free end of the coil 3, passing over a head roller 6, is attached on a receiving spool 5.

In use, a user is able to place the twin adhesive tape lb on an adherent 7 and then move the tape box 2 with exerting a certain pressure on the twin adhesive tape lb. The twin adhesive tape 1b goes from the loading spool 4 to the receiving spool 5 as the tape box 2 moves, leaving the adhesive layer 20b on the adherent. And the FIG. 231b of the adhesive layer 20b is able to be seen.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A twin adhesive tape comprising:
a release substrate; and,
an adhesive layer adhesively and detachably attached to said release substrate; said adhesive layer having a lower adhesive layer, a printing substrate, a thickness of which is between 0.005 and 0.02 millimeter, being securely attached to said lower adhesive layer, a figure formed by a layer of plastic printing ink printed on said printing substrate, and an upper adhesive layer securely attached to said layer of plastic printing ink.

2. The twin adhesive tape as claimed in claim 1, wherein said adhesive layer attaches to said release substrate with said lower adhesive layer thereof and a release cover is attached to said upper adhesive layer of said adhesive layer.

3. The twin adhesive tape as claimed in claim 2, wherein an anti-adhesion coating layer and a cover anti-adhesion coating layer are respectively provided on a surface of said release substrate attaching said adhesive layer and on a surface of said release cover attaching said adhesive layer.

4. The twin adhesive tape as claimed in claim 1, wherein said adhesive layer attaches to said release substrate with said upper adhesive layer thereof and an anti-adhesion coating layer is provided on each surface of said release substrate; said twin adhesive tape being wound into a coil, and used with a hand-held tape box.
